(19) United States
(12) Patent Application Publication
(10) Pub. No.: US 2013/0254021 A1
(43) Pub. Date: Sep. 26, 2013

(54) Systems and Methods for Pull Based Advertisement Insertion

(71) Applicants: Niranjan Damera-Venkata, Fremont, CA (US); William J. Allen, Corvallis, OR (US); Mark W. Van Order, Corvallis, OR (US)

(72) Inventors: Niranjan Damera-Venkata, Fremont, CA (US); William J. Allen, Corvallis, OR (US); Mark W. Van Order, Corvallis, OR (US)

(21) Appl. No.: 13/817,713

(22) PCT Filed: Dec. 13, 2010
(86) PCT No.: PCT/US10/60054

§ 371 Date: Feb. 19, 2013

(51) Int. Cl. G06Q 30/02

(52) U.S. Cl. CPC G06Q 30/0247
USPC 705/14.46

(57) ABSTRACT

The present disclosure includes a system and method for pull based advertisement insertion. In an example of pull based advertisement insertion according to the present disclosure, content (102) to be used in a publication is received, a target revenue value for a future sale of a number of advertisements (250, 252, 254) in the publication (216) is received, a group of advertisements (250, 252, 254) that have been bid on by a number of advertisers to select from for insertion in the publication (216) is received, and a layout (116) for the content (102) and for a number of advertisements (250, 252, 254) selected from the group of advertisements is created, wherein a layout quality is associated with at least one of a number of templates, a number of template parameters, a number of content allocations, an advertisement relevance, an aesthetic quality, and a number of advertisement allocations and wherein the layout quality is above a predetermined threshold layout quality based on the target revenue value (476).

### BACKGROUND

Customization of publications has been desirable, but difficult to achieve throughout the history of print media. With the development of word processing and publishing software for use on computers and the ability for computers to print documents, customization of documents has become increasingly more available. Customization based on reader preference is valuable to content publishers and readers because it can allow publishers to get relevant content to readers and it can allow readers to access content that they are most interested in reading. This customization based on reader preference also allows publishers to target advertising to readers and increase the value of the advertisements to the readers and to the advertising entity. Customization of publication can allow publishers to publish content to a variety of mediums. This allows the same content to reach readers in different formats and allow advertisers to advertise in different formats while the same content is published in different formats.

Customization of print media based on the interests of a reader can have a high marginal cost that can make it cost prohibitive due to the manual work required to personalize print media. Customizing print media is desirable because it would allow for customization of advertising to the reader, which allows the publisher to sell advertisements at a higher cost, the advertiser to reach a targeted audience, and the reader to receive information about products that are relevant to the reader. The quality of advertisements in print media can be higher than other types of media, thus making customization of advertising in print media more valuable because of the increase in quality advertisements that are customized to a reader. Creating a system that reduces or eliminates the manual work of customizing print media and the advertisements in the print media can provide an added benefit to the publisher, the advertiser, and the reader.

### BRIEF DESCRIPTION OF THE DRAWINGS

FIG. 1 is a diagram illustrating components of an example of a publication customization system according to the present disclosure.

FIG. 2 is a template illustrating a content and advertisement layout of a page in an example of a customized publication according to the present disclosure.

FIG. 3 is an example of a Bayesian network illustrating the conditional independencies of templates, template parameters, content allocations, and advertisement allocations in a Bayesian probability model according to the present disclosure.

FIG. 4 is a method flow diagram illustrating an example of pull based advertisement insertion according to the present disclosure.

### DETAILED DESCRIPTION

The present disclosure includes a system and method for pull based advertisement insertion. A method for pull based advertisement insertion can include receiving content to be used in a publication, receiving a target revenue value for a future sale of a number of advertisements in the publication, receiving a group of advertisements that have been bid on by a number of advertisers to select from for insertion in the publication, and creating a layout for the content and for a number of advertisements selected from the group of advertisements, wherein a layout quality is associated with at least one of a number of templates, a number of template parameters, a number of content allocations, an advertisement relevance, an aesthetic quality, and a number of advertisement allocations and wherein the layout quality is above a predetermined threshold layout quality based on the target revenue value.

In some examples, the layout quality can be quantified in a Bayesian probability model that includes random variables associated with templates, template parameters, content allocations, and advertisement allocations.

In the following detailed description of the present disclosure, reference is made to the accompanying drawings that form a part hereof, and in which is shown by way of illustration how examples of the disclosure may be practiced. These examples are described in sufficient detail to enable those of ordinary skill in the art to practice this disclosure, and it is to be understood that other examples may be utilized and that process, electrical, and/or structural changes may be made without, departing from the scope of the present disclosure.

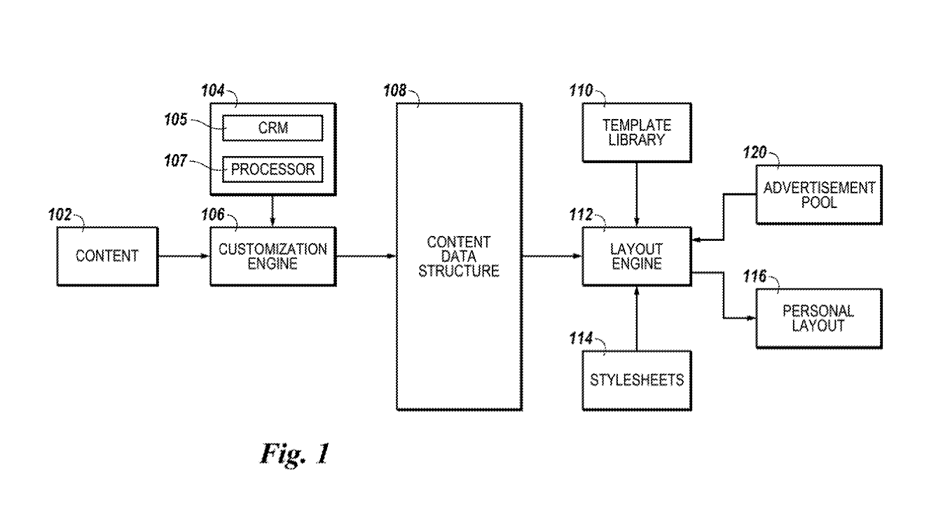

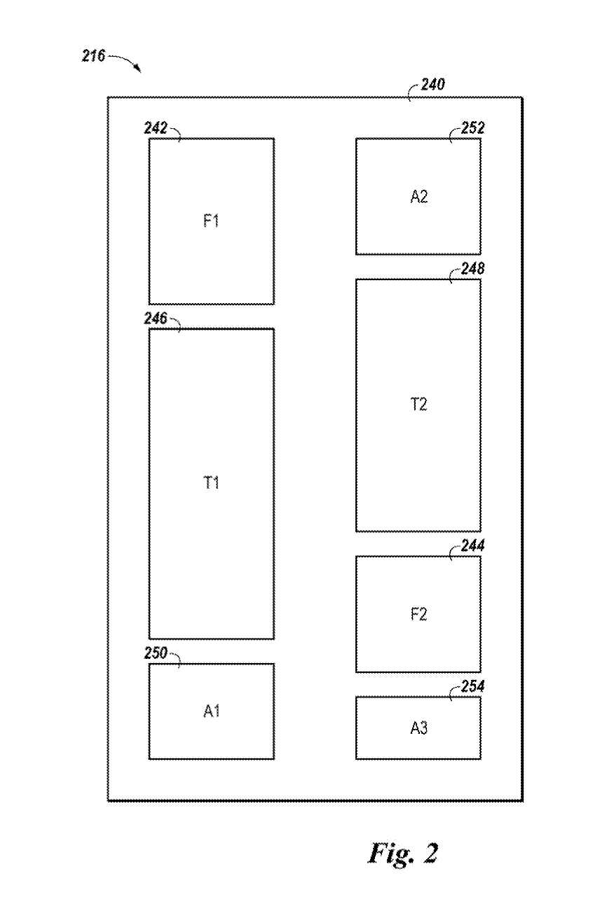

The figures herein follow a numbering convention in which the first digit or digits correspond to the drawing figure number and the remaining digits identify an element or component in the drawing. Similar elements or components between different figures may be identified by the use of similar digits. For example, 116 may reference element “16” in FIG. 1, and a similar element may be referenced as 216 in FIG. 2. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

FIG. 1 is a diagram illustrating components of an example of a publication customization system according to the present disclosure. In FIG. 1, a publication customization system can include a content data structure 108. The content data structure 108 can include the text and figures, the relationships between text and figures, and references between text and figures of content 102 in a customized publication. The content 102 for a publication can include a variety of text and figures relating to a variety of topics. The customization engine 106 can use instructions stored on a computer readable medium 105 to select a portion of the content 102 to include in a customized publication that is targeted to an individual or a group of individuals having similar traits. The content 102 selected by the customization engine 106 for a customized publication can have relationships between text and figures, and references between text and figures of the content 102 defined in the content data structure 108.

In FIG. 1, a publication customization system can include a computing device 104 that includes a processor 107 and a non-transitory computer readable medium (CRM) 105 for executing instructions. The components of the publication customization system can include a number of computing devices that include processors and non-transitory computer readable medium (CRM) for executing instructions. That is, the executable instructions can be stored in a fixed tangible medium communicatively coupled to a number of processors. Memory can include random access memory (RAM), read-only memory (ROM), and/or mass storage devices, such as a hard disk drive, tape drive, optical drive, solid state drive, and/or floppy disk drive.

The non-transitory computer readable media can be programmed with instructions such as an operating system for controlling the operation of the publication customization system. The operating system and/or applications may be implemented as a number of executable instructions stored at a number of locations within volatile and/or non-volatile memory.

In pull based advertisement insertion, a publisher can provide content. A target revenue, and/or a target layout quality can also be provided. The target revenue can be a desired amount of revenue generated by the sale of advertisements in a publication that contains the content. The target layout quality can be a desired layout quality associated with a layout that contains the content. The target revenue and/or the target layout quality can be set by a slider on a linear range of target revenues and/or target layout qualities. The target revenue can be set by a publisher of the publication or by a consumer that would like to read the publication. The amount of revenue generated by the advertisements can be determined by the bids placed for an advertisement slot by an advertiser. In an example, advertisement slots can be auctioned to a number of bidders. A layout can be created with a format for including the content provided by the publisher and the advertisements bid on that generate the revenue intended by the publisher.

A layout for a publication can include the content and the advertisements. The advertisements in the layout can be selected from a pool, e.g., group, of advertisements that were bid on by advertisers. The layout can be customized to maximize the quality of the layout and the revenue generated by the advertisements in the layout. The layout of the advertisements can be created by determining a layout with a layout quality above a predetermined threshold quality, including the relevance of the advertisements to the content, based on the target revenue. The relevance of the advertisement to the content can be considered in determining the layout quality because the advertisements are bid on by advertisers before they are provided to be included in the layout.

The publication customization system in FIG. 1 includes a layout engine 112 that can create a personal layout 116 for the customized publication based on the content data structure 108, templates from a template library 110, stylesheets 114, and an advertisement pool 120. Stylesheets 114 can define the type of content and the formatting of the content used in making a customized publication, the template library 110 can include a number of templates with layouts for the content used in making a customized publication, and the advertisement pool 120 can include a number of advertisements that have been bid on for placement in the personal layout 116.

The layout quality for the content and the advertisements can be dependent on the number of advertisements in a given category, the relevance of the advertisement to the content, and/or the aesthetics of the advertisements in relation to the content layout, among other factors. The quality of a publication can be quantified by at least one of a number of templates, a number of template parameters, a number of content allocations, an advertisement relevance, an aesthetic quality, and a number of advertisement allocations in a publication, among other factors. A layout in an example according the present disclosure can include combinations of templates, template parameters, content allocations, and advertisement allocations that have a layout quality above a predetermined threshold layout quality. The threshold layout quality can be a layout quality that is proximate to a maximum layout quality for a given revenue. The predetermined threshold layout quality can be user-determined or adaptively computed.

FIG. 2 is a template illustrating a content and advertisement layout of a page in an example of a customized publication according to the present disclosure. In FIG. 2, template 216 can be used as the layout for a customized page 240 in a personalized publication. Template 216 can include a first figure field (F1) 242, a second figure field (F2) 244, a first text field (T1) 246, a second text field (T2) 248, a first advertisement slot field (A1) 250, a second advertisement slot field (A2) 252, and a third advertisement slot field (A3) 254. Template 216 can include template parameters that define the dimensions of the figure, text, and advertisement slot fields and the white spaces between the figure, text, and advertisement slot fields.

A number of templates can be created by a designer, where the designer creates a number of arrangements for content and advertisements to meet the needs of a variety of content layouts and a variety of advertisement layouts. A numeric value can be associated with the quality of the template based on the aesthetic desirability of a template's layout. A number of template parameters can be created by a designer, where the template parameters can define the fonts, size of fonts, and/or spacing, among other aspects, of the arrangement of content and advertisements of a template. A numeric value can be associated with the quality of the template parameters based on the aesthetic desirability of the template parameters.

The content allocations that form the content portion of a layout for a publication and the advertisement allocations which form the advertisement portion of a layout for a publication can also affect the quality of the publication. The proximal relationship between the various types of content in the layout can affect the quality of the content allocation and the aesthetic desirability of the layout can also affect the quality of content allocation. A numeric value can be associated with the quality of the content allocation based on these factors, among other factors.

The proximal relationship between the advertisements in the layout can affect the quality of the advertisement allocation and the aesthetic desirability of the layout can also affect the quality of advertisement allocation. A numeric value can be associated with the quality of the advertisement allocation based on these factors, among other factors. The relevance between the advertisements and the content can be used to select which advertisements from a group of advertisement are selected for insertion in an advertisement allocation.

The numeric values associated with the quality of the templates, template parameters, content allocations, and advertisement allocations can be used in a Bayesian probability model. The numeric values associated with the quality of the templates, template parameters, content allocations, and advertisement allocations can be the probability assigned to each template, template parameter, content allocation, and advertisement allocation in the Bayesian probability model. The Bayesian probability model can be used to determine combinations of templates, template parameters, and content allocations that have a layout quality above a predetermined threshold layout quality. The predetermined threshold layout quality can be determined based on a level of desired quality given the factors affect the layout quality. For example, the predetermined threshold layout quality can be user-determined or adaptively computed.

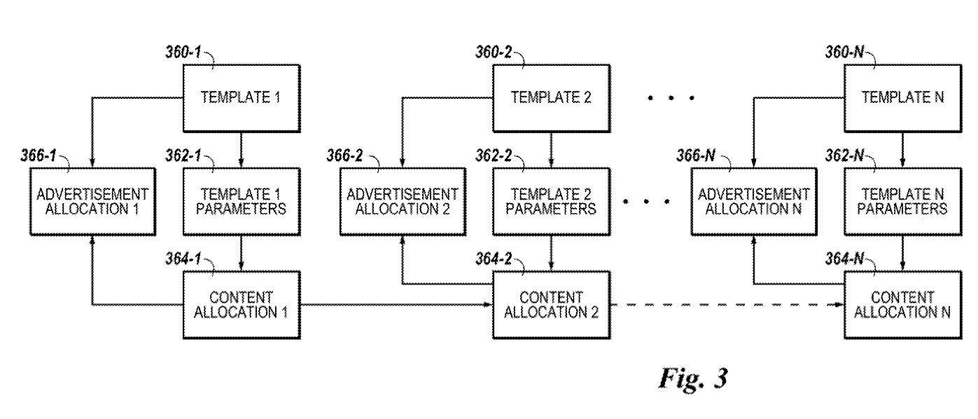

FIG. 3 is an example of a Bayesian network illustrating the conditional independencies of templates, template parameters, content allocations, and advertisement allocations in a Bayesian probability model according to the present disclosure. Each node of the Bayesian network in FIG. 3 illustrates a random variable corresponding to a page in a sample space. For example, node 360-1 represent random variable Template 1 (T₁) associated with a sample set of templates for page 1, node 362-1 represents random variable Template Parameters 1 (Θ₁) associated with a sample set of template parameters for a first page of a publication, node 364-1 represents random variable Content Allocation 1 (C₁) associated with a sample of set of content allocations for a first page of a publication, and node 366-1 represents random variable Advertisement Allocation 1 (A₁) associated with a sample of set of content allocations for a first page of a publication. The arrows between the nodes of the Bayesian network in FIG. 3 illustrate the conditional probabilities between the nodes. For example, the arrow between node 360-1 and 362-1 represents the conditional probability P(Θ₁|T₁) for a set of parameters Θ₁ given a template T₁. The content allocations 364-1, 364-2, . . . , 364-N have more than one parent node, therefore the conditional probability for node 364-2 is P(C₂|C₁, Θ₂). The Bayesian network defines conditional independency structures, so any node is conditionally independent of its non-descendent given its parent, wherein a non-descendent is a node that does not have an arrow indicating dependence pointing to the node. For template nodes 360-1, 360-2, . . . , 360-N, the probabilities associated with these nodes P(T₁), P(T₂), . . . , P(T_{N}) are not conditioned on any other nodes. For template parameter nodes 362-1, 362-2, . . . , 362-N, the probabilities associated with these nodes P(Θ₁|T₁), P(Θ₂|T₂), . . . , P(Θ_{N}|T_{N}) are conditioned on the templates. For advertisement allocation nodes 366-1, 366-2, . . . , 3626N, the probabilities associated with these nodes P(A₁|T₁,C₁), P(A₂|T₂,C₂), . . . , P(A_{N}|T_{N},C_{N}) are conditioned on the templates and the content allocations.

A joint probability distribution that characterizes the conditional probabilities of a Bayesian network is a product of the probabilities of the parent nodes and the conditional probabilities. Thus the joint probability distribution associated with the Bayesian network in FIG. 3 is:

$$P ( \{ Ti \} , \{ Θ i \} , \{ Ai \} , \{ Ci \} ) = P ( {C}_{1} \vert {Θ}_{1} ) P ( {Θ}_{1} \vert {T}_{1} ) P ( {A}_{1} \vert {C}_{1} , {T}_{1} ) P ( {T}_{1} ) … { \prod }_{i = 2}^{N} P ( {C}_{i} \vert {Θ}_{i - 1} {Θ}_{1} ) P ( {Θ}_{i} \vert {T}_{i} ) P ( {A}_{i} \vert {C}_{i} , {T}_{i} ) P ( {T}_{i} )$$

As shown in FIG. 3, content allocation C₁ for the first page “1” is independent, but allocations for each subsequent page depend on the allocation for the previous page. The joint probability distribution associated with the Bayesian network in FIG. 3 is associated with the layout quality of the content and advertisements of a publication.

Examples of the present disclosure can include determining a set of templates, template parameters, content allocations, and advertisement allocations above a predetermined threshold quality and a target revenue based on P({Ti}, {Θi}, {Ai}, {Ci}). Other examples of the present disclosure can include determining a set of templates, template parameters, content allocations, and advertisement allocations above a predetermined threshold revenue and a target layout quality based on P({Ti, {Θi}, {Ai}, {Ci}). The predetermined threshold revenue can be user-determined or adaptively computed.

In order to find the sets {Tᵢ}, {Θᵢ}, {Aᵢ}, and {Cᵢ} for a publication that maximizes the probability P({Ti, {Θi}, {Ai}, {Ci}), the joint probability distribution is defined as follows:

$$\begin{matrix}φ ( {C}_{i} , {C}_{i - 1} ) = {max}_{{A}_{i}} η ( {A}_{i} , {C}_{i} , {C}_{i - 1} ) & Equation ( 1 ) \\ η ( {A}_{i} , {C}_{i} , {C}_{i - 1} ) = {max}_{n} ψ ( {C}_{i} \vert {C}_{i - 1} , {T}_{i} ) P ( {A}_{i} \vert {C}_{i} , {T}_{i} ) P ( {T}_{i} ) & Equation ( 2 ) \\ ψ ( {C}_{i} , {C}_{i - 1} , {T}_{i} ) = {max}_{Θ i} P ( {C}_{i} \vert {C}_{i - 1} , {Θ}_{i} ) P ( {Θ}_{i} \vert {T}_{i} ) & Equation ( 3 )\end{matrix}$$

Equations (1), (2), and (3) are used to determine content allocations, advertisement allocations, templates, and template parameters using the method of “belief propagation” from Bayesian methods. For the sake of simplicity, a description of determining set {Cᵢ} of content allocations using belief propagation is described first, followed by a description of determining an template for each content allocation, determining template parameters for each template, and determining an advertisement allocation for each template and content allocation. However, in practice, optimal content allocations, templates, template parameters, and advertisement allocations can also be determined simultaneously using belief propagation.

The set of advertisement allocations available in the probability distribution for the random variable associated with the advertisement allocations can be determined by solving for each combination of advertisements from a pool, e.g., group, of advertisements that can generate the target revenue or a revenue above a predetermined threshold revenue. The set of advertisement allocations available in the probability distribution can include the set of advertisement allocations included when calculating the number of combinations of advertisements that generate the target revenue or a revenue above a predetermined threshold revenue based on the amount bid for each advertisement in the group of advertisements and then calculating the various orders of each combination of advertisements. Groups of advertisements that satisfy the revenue target, e.g., come within a predetermined threshold of the revenue target, can be selected. In some examples, multiple subsets of the ads may satisfy the revenue target. The method and associated algorithm described below can be run for each possible ordering of advertisements over all groups of advertisements and the publication composition with the best layout quality can then be selected.

The set of content allocations {Cᵢ} that maximized equation (1) can be obtained by first determining the φ's. Each φ is a function of random variables, and is the maximum of a sequence of real numbers, one for each template Tᵢ, as described in equation (2). For each Cᵢ and Cᵢ₋₁ we have a template tᵢ. For the first pages, φ(C₁) is the maximum of the range of real values associated with allocation C₁. For subsequent pages, φ(Cᵢ, Cᵢ₋₁) is the maximum of the range of real values associated with content allocations Cᵢ and Cᵢ₋₁.

After determining the φ's, a set of recursive equations denoted by τ are used to determine the optimal content allocations C₁, C₂, . . . , C_{N}. First, each τ is computed recursively as follows:

$${τ}_{2} ( {C}_{2} ) = {max}_{{C}_{1}} φ ( {C}_{1} ) \times φ ( {C}_{1} , {C}_{2} )$$

$${τ}_{N - 1} ( {C}_{N - 1} ) = {max}_{{C}_{N - 2}} {τ}_{N - 2} ( {C}_{N - 2} ) \times φ ( {C}_{N - 1} , {C}_{N - 2} ) , \\ and$$

$${τ}_{N} ( {C}_{N} ) = {max}_{{C}_{N - 1}} {τ}_{N} ( {C}_{N} ) \times φ ( {C}_{N - 1} , {C}_{N} )$$

After, each of the τi's have been recursively obtained, content allocations C₁, C₂, . . . , C_{N} can be obtained by solving the τi 's in a reverse recursive manner as follows:

$${C}_{N - 1}^{*} = arg {max}_{{C}_{N - 1}} {τ}_{N - 1} ( {C}_{N - 1} ) \times φ ( {C}_{N - 1} , {C}_{N}^{*} )$$

$$and$$

$${C}_{i - 1}^{*} = arg {max}_{{C}_{i - 1}} τ {i}_{- 1} ( {Ci}_{- 1} ) \times φ ( {Ci}_{- 1} , {C}_{i}^{*} )$$

Thus, content allocations C_{I}, C₂, . . . , C_{N} for maximizing the probability P*({Ti, {Θi}, {Ai}, {Ci}) have been determined.

After the set of content allocations have been determined, for each content allocation, equations (1), (2), and (3) can be used to determine an associated Tᵢ, Θᵢ, Aᵢ. For each Cᵢ there is a set of Tᵢ's. Once a φ(Cᵢ, Cᵢ₋₁) is determined, the corresponding Tᵢ provides the solution for equation (1) on the corresponding template parameters Θᵢ provides the solution to equation (2), and the corresponding Aᵢ provides the solution to equation (3).

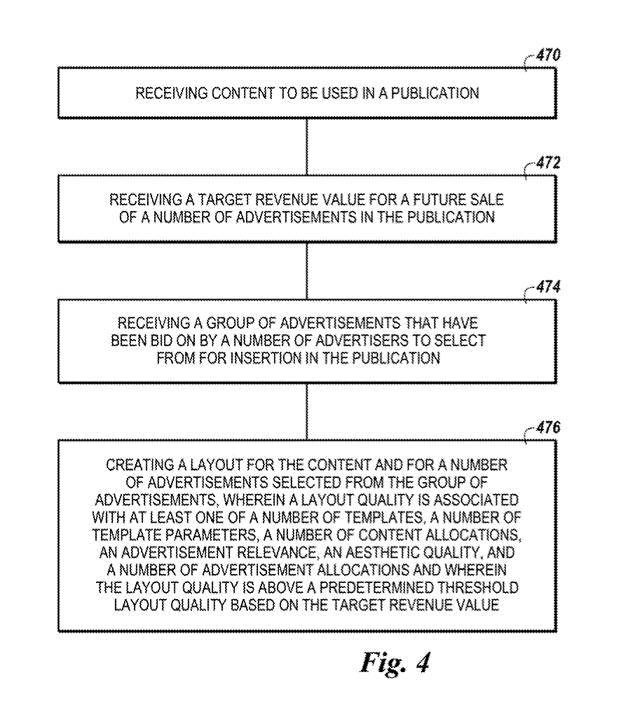

FIG. 4 is a method flow diagram illustrating an example of pull based advertisement insertion according to the present disclosure A method for pull based advertisement insertion can include receiving content to be used in a publication 470, receiving a target revenue value for a future sale of a number of advertisements in the publication 472, receiving a group of advertisements that have been bid on by a number of advertisers to select from for insertion in the publication 474, and creating a layout for the content and for a number of advertisements selected from the group of advertisements, wherein a layout quality is associated with at least one of a number of templates, a number of template parameters, a number of content allocations, an advertisement relevance, an aesthetic quality, and a number of advertisement allocations and wherein the layout quality is above a predetermined threshold layout quality based on the target revenue value 476.

In some examples, creating the layout for the content and for the number of advertisements can include selecting a number of advertisements from the group of advertisements to create a set of relevant advertisements to include in the layout based on the relevance of the number of advertisements to the content. Creating the layout for the content and for the number of advertisements can include generating a number of groups of advertisements from the set of relevant advertisements, wherein each of the number of groups of advertisements have an associated revenue within a threshold of a target revenue.

In some examples, the layout quality associated with at least one of the number of templates, the number of template parameters, the number of content allocations, and at least one ordering of at least one of the number of groups of advertisements can be quantified in a Bayesian probability model. The layout quality associated with each ordering of each of the number of groups of advertisements in a Bayesian probability model can be quantified. The Bayesian probability model can be solved to determine the layout with the layout quality that is above the predetermined threshold layout quality based on the target revenue value.

In an example according to the present disclosure, a system for pull based advertisement insertion can include a layout engine, wherein the layout engine receives content for a publication, a target revenue value associated with a sale of a number of advertisements for the publication, and a group of advertisements for insertion in the publication and contemporaneously selects a number of templates, a number of template parameters, a number of content allocations, and a number of advertisement allocations to create a layout for the publication, wherein a layout quality is associated with at least one of the number of templates, the number of template parameters, the number of content allocations, and the number of advertisement allocations and wherein the layout quality is above a predetermined threshold layout quality based on the target revenue value.

In some examples, the layout engine can select a number of advertisements from the group of advertisements to create a set of relevant advertisements for the layout based on the relevance of the number of advertisements to the content. The layout engine can generate a number of groups of advertisements from the set of relevant advertisements, wherein each of the number of groups of advertisements have an associated revenue within a threshold of a target revenue.

An example according to the present disclosure can include a non-transitory computer readable medium having instructions stored thereon executable by a processor to create a layout for content and a number of advertisements in a publication based on a target layout quality, wherein a layout quality is based on at least one of a number of templates, a number of template parameters, a number of content allocations, and a number of advertisement allocations of the layout; and wherein revenue associated with bids placed on a number of advertisements in the layout is above a predetermined threshold revenue based upon the target layout quality.

In some examples, the layout quality can be quantified by a Bayesian probability model that includes random variables associated with at least one of the number of templates, the number of template parameters, the number of content allocations, and the number of advertisement allocations of the layout. The Bayesian probability model can be solved to determine the layout so the revenue associated with bids placed on a number of advertisements is above the predetermined threshold revenue based upon the target layout quality.

Although specific examples have been illustrated and described herein, those of ordinary skill in the art will appreciate that an arrangement calculated to achieve the same results can be substituted for the specific examples shown. This disclosure is intended to cover adaptations or variations of a number of examples of the present disclosure. It is to be understood that the above description has been made in an illustrative fashion, and not a restrictive one. Combination of the above examples, and other examples not specifically described herein will be apparent to those of skill in the art upon reviewing the above description. The scope of the number of examples of the present disclosure includes other applications in which the above structures and methods are used. Therefore, the scope of number of examples of the present disclosure should be determined with reference to the appended claims, along with the full range of equivalents to which such claims are entitled.

Various examples of the system and method for advertisement insertion have been described in detail with reference to the drawings, where like reference numerals represent like parts and assemblies throughout the several views. Reference to various examples does not limit the scope of the system and method for displaying advertisements, which is limited only by the scope of the claims attached hereto. Additionally, any examples set forth in this specification are not intended to be limiting and merely set forth some of the many possible examples for the claimed system and method for scheduling changes.

Throughout the specification and claims, the meanings identified below do not necessarily limit the terms, but merely provide illustrative examples for the terms. The meaning of “a,” “an,” and “the” includes plural reference, and the meaning of “in” includes “in” and “on.” The phrase “in an example.” as used herein does not necessarily refer to the same example, although it may.

In the foregoing Detailed Description, some features are grouped together in a single example for the purpose of streamlining the disclosure. This method of disclosure is not to be interpreted as reflecting an intention that the disclosed examples of the present disclosure have to use more features than are expressly recited in each claim. Rather, as the following claims reflect, the claimed subject matter can lie in fewer than all features of a single disclosed example. Thus, the following claims are hereby incorporated into the Detailed Description, with each claim standing on its own as a separate example.

What is claimed:

1. A computer implemented method for pull based advertisement insertion, the method comprising:
receiving content (102) to be used in a publication;
receiving a target revenue value for a future sale of a number of advertisements (250, 252, 254) in the publication (216);
receiving a group of advertisements (250, 252, 254) that have been bid on by a number of advertisers to select from for insertion in the publication (216); and
creating a layout (116) for the content (102) and for a number of advertisements (250, 252, 254) selected from the group of advertisements, wherein a layout quality is associated with at least one of a number of templates, a number of template parameters, a number of content allocations, an advertisement relevance, an aesthetic quality, and a number of advertisement allocations and wherein the layout quality is above a predetermined threshold layout quality based on the target revenue value (476).

2. The method of claim 1, wherein creating the layout (116) for the content (102) and for the number of advertisements (250, 252, 254) includes selecting a number of advertisements from the group of advertisements to create a set of relevant advertisements to include in the layout (116) based on the relevance of the number of advertisements to the content.

3. The method of claim 1, wherein creating the layout (116) for the content (102) and for the number of advertisements (250, 252, 254) includes generating a number of groups of advertisements from the set of relevant advertisements, wherein each of the number of groups of advertisements have an associated revenue within a threshold of a target revenue.

4. The method of claim 1, wherein the method includes quantifying the layout quality associated with at least one of the number of templates, the number of template parameters, the number of content allocations, and at least one ordering of at least one of the number of groups of advertisements in a Bayesian probability model (360, 362, 364, 366).

5. The method of claim 4, wherein the method includes quantifying the layout quality associated with each ordering of each of the number of groups of advertisements in a Bayesian probability model (360, 362, 364, 366).

6. The method of claim 1, wherein the method includes solving the Bayesian probability model (360, 362, 364, 366) to determine the layout with the layout quality that is above the predetermined threshold layout quality based on the target revenue value.

7. The method of claim 1, wherein receiving the target revenue value (476) includes setting a slider that determines the target revenue value (476).

8. A system for pull based advertisement insertion, the system comprising:
a layout engine (112), wherein the layout engine (112) is configured to:
receive content (102) for a publication, a target revenue value associated with a sale of a number of advertisements (250, 252, 254) for the publication (216), and a group of advertisements for insertion in the publication (216); and
select a number of templates, a number of template parameters, a number of content allocations, and a number of advertisement allocations to create a layout for the publication (216), wherein a layout quality is associated with at least one of the number of templates, the number of template parameters, the number of content allocations, and the number of advertisement allocations and wherein the layout quality is above a predetermined threshold layout quality based on the target revenue value (476).

9. The system of claim 8, wherein the layout engine selects a number of advertisements from the group of advertisements to create a set of relevant advertisements for the layout based on the relevance of the number of advertisements to the content (476).

10. The system of claim 8, wherein the layout engine generates a number of groups of advertisements from the set of relevant advertisements, wherein each of the number of groups of advertisements have an associated revenue within a threshold of a target revenue (476).

11. The system of claim 8, wherein the layout quality associated with at least one of the number of templates, the number of template parameters, the number of content allocations, and at least one ordering of at least one of the number of groups of advertisements is quantified in a Bayesian probability model (360, 362, 364, 366).

12. The system of claim 11, wherein the Bayesian probability model (360, 362, 364, 366) quantifying the layout quality is solved to determine the layout with a layout quality that is above the predetermined threshold layout quality based on the target revenue value (476).

13. A non-transitory computer readable medium having instructions stored thereon executable by a processor to:
create a layout (116) for content (102) and a number of advertisements (250, 252, 254 in a publication (216) based on a target layout quality, wherein a layout quality is based on at least one of a number of templates, a number of template parameters, a number of content allocations, and a number of advertisement allocations of the layout (476); and
wherein revenue associated with bids placed on a number of advertisements in the layout is above a predetermined threshold revenue based upon the target layout quality (476).

14. The non-transitory computer readable medium of claim 13, wherein the layout quality is quantified by a Bayesian probability model (360, 362, 364, 366) that includes random variables associated with at least one of the number of templates, the number of template parameters, the number of content allocations, and the number of advertisement allocations of the layout and wherein the Bayesian probability model (360, 362, 364, 366) is solved to determine the layout so the revenue associated with bids placed on a number of advertisements is above the predetermined threshold revenue based upon the target layout quality (476).

15. The non-transitory computer readable medium of claim 13, wherein the layout includes a number of advertisements that are selected for the layout based on a relevance of the number of advertisements to the content (476).
